(19) United States
(12) Patent Application Publication
(10) Pub. No.: US 2013/0088562 A1
(43) Pub. Date: Apr. 11, 2013

(54) COMMUNICATION TERMINAL FOR PROVIDING SILHOUETTE FUNCTION ON VIDEO SCREEN FOR VIDEO CALL AND METHOD THEREOF

(71) Applicants: JUNG SOO HONG, GUNPO-SI (KR); HEUNG SOO PARK, NAMYANGJU-SI (KR)

(72) Inventors: JUNG SOO HONG, GUNPO-SI (KR); HEUNG SOO PARK, NAMYANGJU-SI (KR)

(73) Assignee: HANWHA SOLUTION & CONSULTING CO., LTD, SEOUL (KR)

(21) Appl. No.: 13/287,844

(22) Filed: Nov. 2, 2011

(30) Foreign Application Priority Data
Oct. 7, 2011 (KR) 10-2011-0102399

(51) Int. Cl. H04N 7/14

(52) U.S. Cl. 348/14.07; 348/E07.078

(57) ABSTRACT

A communication terminal provides a silhouette function on a video screen for a video call and a method thereof. The communication terminal may include a video input unit to receive an input of a video signal for a video call from a camera, a body recognition unit to recognize a body image of a user captured through the camera in the video signal, a silhouette processing unit to silhouette an area corresponding to the body image in the video signal, and a video output unit to output the video signal including the silhouetted body image to at least one opposite party communication terminal.

### CROSS-REFERENCE TO RELATED APPLICATION

The present application claims the benefit of Korean Patent Application No. 10-2011-0102399, filed on Oct. 7, 2011, in the Korean Intellectual Property Office, which is incorporated herein by reference in its entirety.

### TECHNICAL FIELD

Exemplary embodiments of the present invention relate to a communication terminal capable of protecting the appearance of a user while maintaining a background image to provide a realistic sense during a video call.

### BACKGROUND

With the development of mobile communication technologies and terminal manufacturing technologies, recent mobile communication terminals provide a variety of additional functions as well as a voice call function while being mobile. For example, the additional functions enable a user to exchange photos with another party, download moving images from a server, play online games via a wireless Internet connection, and the like. In particular, as mobile communication terminals having a high-performance camera become wide-spread, particular attention is being paid to a video call function. Also, with the commercialization of technologies capable of high speed data transmission such as high speed downlink packet access (HSDPA) and the like, the usage of a video call using mobile communication terminals is increasing rapidly.

A video call basically pursues a realistic sense to enable a user to perceive another party as being directly in front of the user by implementing a face-to-face communication. However, in some circumstances, the user is reluctant to reveal a face or clothing of the user to the other party. In this case, conventionally, the user would change the direction of a camera or turn off a monitor.

Also, a video call using conventional mobile communication terminals involves a controversial issue of infringing on the privacy of a user due to revealing of a location of the user and the like. To solve this problem, image replacement solutions have been suggested for replacing a background image with another image or transmitting a previous picture or image in place of a current image.

Korean Patent Publication No. 10-2008-0044380 discloses an image replacement scheme for searching for a suitable image for video call situations and outputting the image to another party.

However, when a user turns off a monitor or transmits a replacement image to avoid revealing the appearance of the user, a realistic situation of the user is not conveyed to another party so that the other party may become impatient with the lack of a realistic sense, and consequently, an active communication between the user and the other party is halted.

In this specification, a video call scheme capable of avoiding revealing the appearance of a user while maintaining the background to provide a realistic sense during a video call is disclosed.

### SUMMARY

An aspect of the present invention provides a communication terminal that may protect the appearance of a user on a video screen without losing a realistic sense during a video call, and a method thereof.

Another aspect of the present invention also provides a communication terminal that may silhouette a body image of a user, while maintaining a background image on a video screen during a video call, and a method thereof.

According to an aspect of the present invention, there is provided a communication terminal including a video input unit to receive an input of a video signal for a video call from a camera, a body recognition unit to recognize a body image of a user captured through the camera in the video signal, a silhouette processing unit to silhouette an area corresponding to the body image in the video signal, and a video output unit to output the video signal including the silhouetted body image to at least one opposite party communication terminal.

In an aspect of the present invention, the body recognition unit may detect an outline of the body in an image from the video signal, and the silhouette processing unit may change a color within the outline to a single color.

In another aspect of the present invention, the communication terminal may further include an interface unit to receive an input of a silhouette function for the video call from the user. In this instance, the silhouette processing unit may silhouette the body image when the silhouette function is input from the user.

In still another aspect of the present invention, the video signal including the silhouetted body image may be output to a screen provided to the user and a screen provided through the opposite party communication terminal.

According to another aspect of the present invention, there is provided a video call method in a communication terminal, including receiving an input of a video signal for a video call from a camera, recognizing a body image of a user captured through the camera in the video signal, silhouetting an area corresponding to the body image in the video signal, and outputting the video signal including the silhouetted body image to at least one opposite party communication terminal.

According to exemplary embodiments of the present invention, the appearance of a user on a video screen may be protected by silhouetting a body image of the user in an input video source for a video call.

In the input video source, only the body image of the user may be silhouetted while maintaining a background image, thereby avoiding the exposure of a face or clothing of the user and maintaining a natural and a realistic sense of a video call.

Accordingly, a silhouette function may be employed, gainfully, in various video services such as a video call, a video conference, and the like, leading to activation of a video service. Also, the silhouette function may be effectively used for applications where a person is reluctant to expose their identity but is forced to be present at a video call in person, such as telecommunication based-suspect interrogation and the like.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an internal configuration of a communication terminal for silhouetting a body image of a user during a video call, according to an embodiment of the present invention;

FIG. 2 is a diagram illustrating a user menu related to a silhouette function according to an embodiment of the present invention;

FIG. 3 is a diagram illustrating silhouette processing of a body image of a user in an input video source according to an embodiment of the present invention; and

FIG. 4 is a flowchart illustrating a video call method in a communication terminal for silhouetting a body image of a user during a video call, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Exemplary embodiments of the present invention may be applied to a communication terminal supporting a one-to-one or one-to-many video call. Here, the communication terminal may include all communication terminals with a video call function, for example, a personal computer (PC), a tablet PC, a smart phone, and the like.

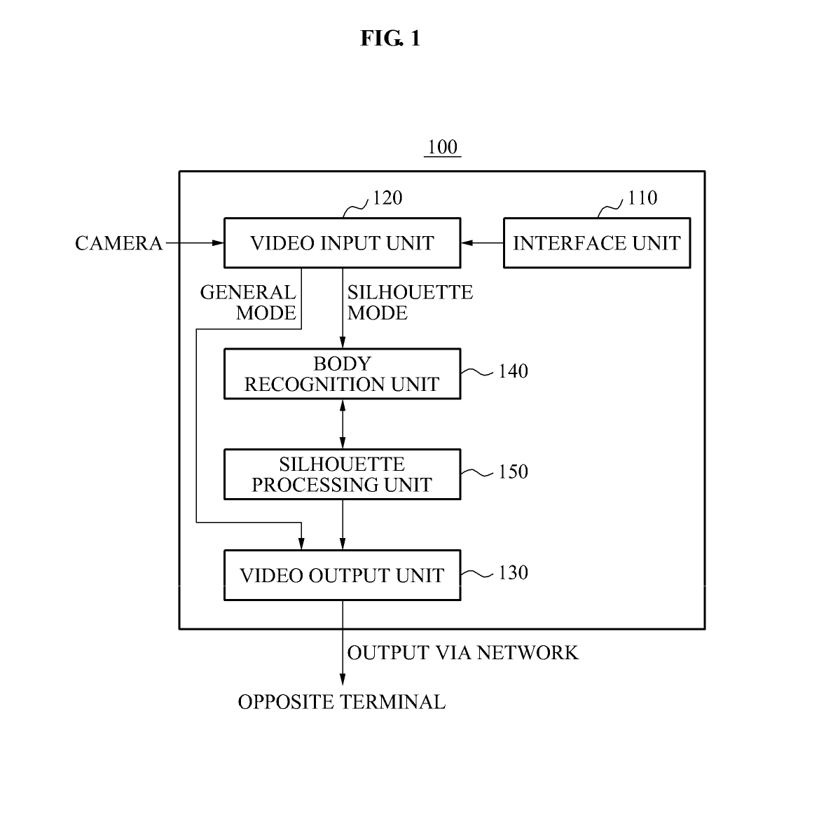

FIG. 1 is a block diagram illustrating an internal configuration of a communication terminal for silhouetting a body image of a user during a video call, according to an embodiment of the present invention. As shown in FIG. 1, a communication terminal 100 according to an embodiment of the present invention may include an interface unit 110, a video input unit 120, a video output unit 130, a body recognition unit 140, and a silhouette processing unit 150. Here, the communication terminal 100 may have a camera embedded therein or may be linkable with a separate external camera, for a video call.

The interface unit 110 may receive an input of a user about whether a silhouette function is to be implemented on a video call. In this exemplary embodiment, the silhouette function may be a function of silhouetting a body image of a user in an input video source to avoid revealing a face or clothing of the user during a video call. For this purpose, the interface unit 110 may provide a user menu related to the silhouette function.

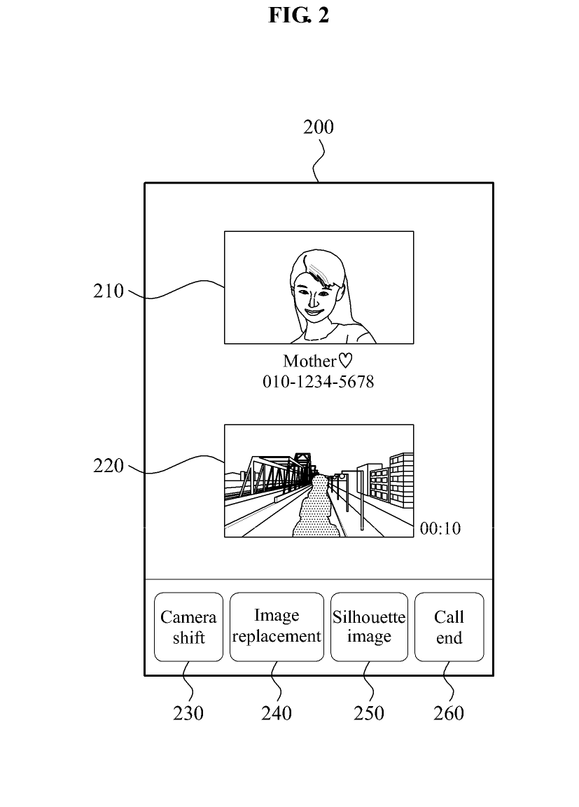

FIG. 2 is a diagram illustrating a user menu related to a silhouette function according to an embodiment of the present invention.

Referring to FIG. 2, when sending or receiving a call, a video call screen 200 may have another party display 210 displaying a video of the other party and a user display 220 displaying a video of a user. Also, the video call screen 200 may provide a plurality of menus related to a video call that are activated, including a camera shift menu 230 for changing the direction of a camera, an image replacement menu 240 for transmitting an image replaced for a video of a user, and a call end menu 260 for ending a video call. In this exemplary embodiment, the interface unit 110 may further provide a silhouette image menu 250 for implementing a silhouette function through the video call screen 200. That is, when a video of a user is in operation and can be viewed by another party, the user may use a silhouette function during a video call by inputting the silhouette image menu 250 among the activated user menus on the video call screen 200.

The video input unit 120 may receive an input of a video source for a video call, that is, a video signal for a video call from a camera. In this instance, when a request for implementation of a silhouette function is not input through the interface unit 110 (hereinafter referred to as a ‘general mode’), the video input unit 120 may immediately transmit the video signal input from the camera to the video output unit 130. When a request for implementation of a silhouette function is input through the interface unit 110 (hereinafter referred to as a ‘silhouette mode’), the video input unit 120 may transmit the video signal input from the camera to the body recognition unit 140.

The video output unit 130 may output the video signal for a video call to at least one other party communication terminal (hereinafter referred to as an ‘opposite terminal’). To make a one-to-one or one-to-many video call depending on a request by the user, the video output unit 130 may output the video signal of the user to the opposite terminal in real time using connection information of the other party designated by the user, for example, a telephone number, and the like. In this instance, in a general mode, the video output unit 130 may receive the video signal from the video input unit 120 and may transmit the video signal to the opposite terminal. In a silhouette mode, the video output unit 130 may receive the video signal from the silhouette processing unit 150 and may transmit the video signal to the opposite terminal.

The silhouette mode of the video call may be executed by the body recognition unit 140 and the silhouette processing unit 150.

In the silhouette mode, the body recognition unit 140 may receive the video signal from the video input unit 120 and may recognize a body image of the user captured through the camera in the input video signal. The body recognition unit 140 may distinguish the body of the user from the background in an image from the video signal using information of brightness, movement, color, face location estimation, eye location estimation, and the like. For example, the body recognition unit 140 may detect an outline of the body in an image from the video signal based on various algorithms, for example, edge detection in a gray scale image, edge detection using a disparity map based on the difference in light intensity, and the like.

The silhouette processing unit 150 may silhouette an area corresponding to the body image recognized by the body recognition unit 140 in the video signal. In the silhouette processing, the silhouette processing unit 150 may maintain color information in the video signal as an original for an area corresponding to the background image in the video signal, and may change color information only for an area corresponding to the body image in the video signal to avoid exposing a face or clothing of the user. In other words, the silhouette processing unit 150 may change a color within the outline of the body detected by the body recognition unit 140 to a single color.

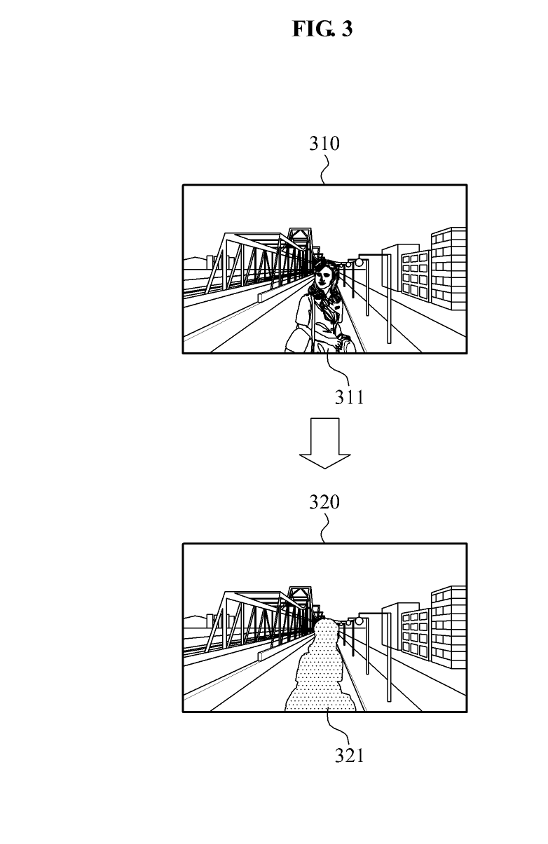

FIG. 3 is a diagram illustrating silhouette processing of a body image of a user in an input video source according to an embodiment of the present invention.

Referring to FIG. 3, the silhouette processing unit 150 may silhouette a body image 311 detected in an original video 310 by changing the color within the body image 311 to a single color, and may use a video 320 including a silhouetted body image 321 as a final video to be transmitted to the opposite terminal.

The silhouette processing unit 150 may transmit the video signal including the silhouetted body image to the video output unit 130 to transmit the silhouetted body image to the opposite terminal. Also, the silhouette processing unit 150 may output the video signal including the silhouetted body image to a terminal monitor (not shown) to display the silhouetted body image to the user. Accordingly, the video signal including the silhouetted body image may be output to a screen provided to the user and a screen provided through the opposite terminal, so that the video signal including the silhouetted body image may be seen by both the user and the other party.

According to this exemplary embodiment, the communication terminal of the foregoing configuration may silhouette a body image of a user in an input video source for a video call, thereby protecting the appearance of the user on a video screen.

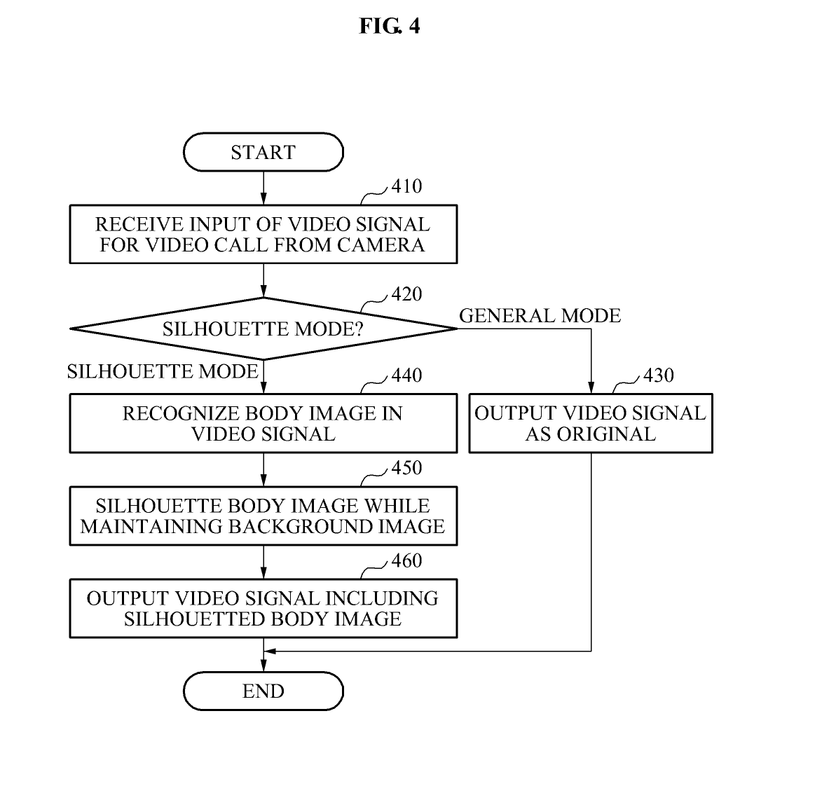

FIG. 4 is a flowchart illustrating a video call method in a communication terminal which may silhouette a body image of a user during a video call, according to an embodiment of the present invention. The video call method according to an embodiment of the present invention may be performed by the communication terminal 100 of FIG. 1 for each operation.

In operation 410, the communication terminal 100 may receive an input of a video signal for a video call from a camera.

In operation 420, the communication terminal 100 may check an input of a user about whether to implement a silhouette function on a video call. The communication terminal 100 may provide a silhouette image menu for implementing the silhouette function through a video call screen when sending or receiving a call, and then, the user may implement the silhouette function using the silhouette image menu during a video call.

In operation 430, when the user requests a video call in a general mode without implementing the silhouette function, the communication terminal 100 may output the input video signal received from the camera as original to at least one opposite terminal.

In operation 440, when the user requests a video call in a silhouette mode by implementing the silhouette function, the communication terminal 100 may recognize a body image of the user captured through the camera in the input video signal received from the camera. In this instance, the communication terminal 100 may detect an outline of the body in an image from the video signal, thereby distinguishing the body of the user from a background in the video signal.

In operation 450, the communication terminal 100 may silhouette an area corresponding to the body image recognized in operation 440. In other words, the communication terminal 100 may change the color within the body image to a single color while maintaining color information of the background image in the video signal as original, relative to the outline of the body.

In operation 460, the communication terminal 100 may output the video signal including the silhouetted body image to at least one opposite terminal. In this instance, the communication terminal 100 may output the video signal including the silhouetted body image to a screen provided to the user as well as to a screen provided through the opposite party terminal.

As described in the foregoing, the exemplary embodiments of the present invention may silhouette a body image of a user in an input video source while maintaining a background image, thereby avoiding the exposure of a face or clothing of the user and maintaining a natural and a realistic sense of a video call. Accordingly, a silhouette function may be usefully employed in various video services such as a video call, a video conference, and the like, leading to activation of a video service. Also, the silhouette function may be effectively used for applications where a person is reluctant to expose the identity but is forced to personally attend a video call, such as telecommunication based-suspect interrogation and the like.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it will be appreciated by those skilled in the art that changes may be made to these exemplary embodiments without departing from the principles and spirit of the invention, the scope of which is defined by the claims and their equivalents.

What is claimed is:

1. A communication terminal comprising:
a video input unit to receive an input of a video signal for a video call from a camera;
a body recognition unit to recognize a body image of a user captured through the camera in the video signal;
a silhouette processing unit to silhouette an area corresponding to the body image in the video signal; and
a video output unit to output the video signal including the silhouetted body image to at least one opposite party communication terminal.

2. The communication terminal of claim 1, wherein the body recognition unit detects an outline of the body in an image from the video signal, and the silhouette processing unit changes a color within the outline to a single color.

3. The communication terminal of claim 1, further comprising:
an interface unit to receive an input of a silhouette function for the video call from the user,
wherein the silhouette processing unit silhouettes the body image when the silhouette function is input from the user.

4. The communication terminal of claim 1, wherein the video signal including the silhouetted body image is output to a screen provided to the user and a screen provided through the opposite party communication terminal.
